(19) United States
(12) Patent Application Publication
(10) Pub. No.: US 2009/0290464 A1
(43) Pub. Date: Nov. 26, 2009

(54) Data Protection in an Optical Data Carrier

(75) Inventor: Andrew N. SHIPWAY, Jerusalem (IL)

Correspondence Address: HOUSTON ELISEEVA, 4 MILITIA DRIVE, SUITE 4, LEXINGTON, MA, 02421, US

(73) Assignee: MEMPILE INC., Wilmington, DE (US)

(21) Appl. No.: 12/477,983

(22) Filed: Jun. 4, 2009

Related U.S. Application Data
(63) Continuation of application No. PCT/IL2007/001493, filed on Dec. 4, 2007.
(60) Provisional application No. 60/872,512, filed on Dec. 4, 2006.

(51) Int. Cl. G11B 27/36

(52) U.S. Cl. 369/53.21; G9B/27.052

(57) ABSTRACT

An optical data carrier is presented being configured to provide protection for data recordable therein from environmental effects. The optical data carrier comprises recordable media having an outer surface and an inner data volume in which data is to be recorded, said data volume being spaced from said outer surface a certain minimal distance D, a region of the recordable media surrounding the data volume providing at least optical protection for said data volume.

### RELATED APPLICATIONS

This application is a Continuation of International Application No. PCT/IL2007/001493, filed on Dec. 4, 2007, which in turn claims the benefit under 35 USC 119(e) of U.S. Provisional Application No. 60/872,512, filed on Dec. 4, 2006, both of which are incorporated herein by reference in their entirety.

### FIELD OF THE INVENTION

This invention is generally in the field of optical data carriers and relates to data protection in such carriers. The invention is particularly useful for optical data carriers utilizing a non-linear recording medium enabling recorded data to be arranged in a three-dimensional pattern of spaced-apart recorded regions located in multiple virtual layers.

### BACKGROUND OF THE INVENTION

The conventional optical data storage technologies utilize disk-like information carriers, such as CD and DVD, often incorporating a protective cover layer between the data-containing layer and the outer surface of the disk. This cover layer is made from a transparent material and has an appropriate thickness (up to 1.2 mm thick) to protect the data structure (data-containing layer) from physical damage and to allow a laser beam to pass through to access the data-containing layer.

The cover layer is typically designed to enable the laser beam propagation therethrough with a relatively large spot (rather than as a focused point), in which case small disruptions in the quality of the disk surface (e.g. scratches, fingerprints) are less likely to cause errors during the data manipulation processes.

The cover layer (or a thin surface portion thereof) may also be designed to provide other advantageous properties to the surface of the disk, such as scratch resistance, antistatic, antireflection or decorative color.

Special coatings are used in conventional reflective media to protect from mechanical damage data that is as close as 0.1 mm to the disk surface. There are also miniaturized reflective media examples in which data is recorded or embossed on the surface of a disk and protected only by a cartridge.

In optical information carrier utilizing photochemical recording media, a data-containing layer may also need to be protected from ambient light of particular wavelengths since such light, e.g. from sunlight or environmental lighting, could cause undesirable photochemical processes to occur in the recording media. One solution to this problem is to keep the disk contained within a cartridge, from which it is only exposed during data manipulation processes (inside the controlled environment of the disk drive). Another solution is to include a dichroic coating in the cover layer or surface of the disk, which bars the incidence of damaging wavelengths of light. JP 06/134365 discloses such a layer, e.g. a wavelength selective absorption material capable of transmitting waves of certain length and shielding against waves of different length. Yet another known solution against deleterious wavelengths is to include a dye in the cover layer (or part thereof) which substantially absorbs any ambient radiation of potentially damaging wavelengths so that it can not reach the data-containing layer.

### SUMMARY OF THE INVENTION

There is a need in the art for a novel data protection technique for use in optical data carriers, allowing protection for a data-containing portion of the carrier from various environmental effects (including mechanical and optical effects), to thereby improve performance of optical information carriers.

The above-mentioned known data protection techniques do not provide fully satisfactory solutions. Indeed, embedding an optical data carrier in a cartridge adds cost and bulk to the entire system, is less appealing to the consumer, and may be accidentally compromised, e.g. by a curious child or faulty mechanism. The use of dichroic coatings is expensive and fragile. The use of a dye-containing cover layer relies on the ability to find a dye having absorption characteristics very closely matching the damaging wavelengths of light without absorbing any wavelengths required for the recording and/or playback of information, which is a very difficult task. In addition, this method also requires the technology to incorporate the dye into the cover layer material at an appropriate concentration and apply the cover layer to the disk in a near-perfect optical quality.

In order to enable wide use of photochemical data storage media, the data layer may also need to be protected from ambient light of particular wavelengths. Information is recorded in such carriers on virtual layers as series of a three-dimensional pattern of spaced-apart marks (recorded regions). When a recorded mark is excited by appropriate laser radiation, the mark emits radiation at a wavelength different from the excitation wavelength. The mechanism that causes the mark to emit radiation is luminescence. The luminescence response of the excited mark is relatively weak, and one of the problems associated with the reading of such carrier is the polymer transparency to the luminescent radiation wavelength. The known protective layers, and especially dichroic and dye containing coatings, change the disc transparency and their application to a photochemical disc would prevent one from reading the recorded data.

Therefore, substantial development effort is required to bring a different approach to mass production, and even then, it adds to the cost of the disk. The protection layer or coating should be such that it will not affect the disc transparency.

The present invention provides a novel approach in protecting data in optical data carriers, which is especially useful in the optical information carriers of a kind allowing data recording in and reading from multiple data layers (e.g. virtual layers), namely in the data carriers utilizing non-linear recordable media or photochemically-active recordable media. In such media at least one of data recording and reproducing (reading) processes may be based on multi-photon interaction (e.g. two-photon interaction), and a read signal is in the form of a fluorescence pattern indicative of the recorded data pattern. The latter is in the form of a three-dimensional pattern of spaced-apart marks (recorded regions) arranged in multiple virtual planes (layers).

According to the present invention, a data carrier comprises recordable medium volume where data is to be recorded (termed “data volume”) characterized by certain spectral and/or dispersion properties, and comprises a protective region or layer having spectral and/or dispersion properties similar to those of the data volume. The protective region is a region of the photochemically-active medium of the same or similar spectral and/or dispersion properties as those of the data volume and surrounding the data volume at the sides of the data carrier which might be exposed to ambient/harmful radiation and other environmental effects. In other words, the data volume is embedded in the photochemically-active media at a certain minimal distance from an outer surface of the media. This minimal distance is selected in accordance with the desired spectral properties of the protection volume.

Selection of a thickness of the protecting layer/region (or selection of the depth for the data-layers arrangement) is governed by the desired level of protection and acceptable loss of the data carrier capacity. The data recording and reading on and from the selected depth in the recordable medium can then be governed and achieved by the use of appropriate optics (e.g. lens units) and a relative displacement between the optical beam and the recordable medium.

In some embodiments of the invention, the protective region is an intact layer of the recordable medium. This is implemented by arranging the data volume (data-containing planes/layers) at a certain selected minimal depth within the photochemically-active recordable medium.

In some other embodiments of the invention, the data carrier may be a stack of at least two monolithic plates, each comprising a recordable medium. In this case, the top and/or bottom plate(s) contain(s) the protective layer(s)/region(s) extending from the respective top and/or bottom outer surface(s) of the data carrier up to a certain minimal distance. In these embodiments, the data volume of the entire data carrier may actually be considered as being actually formed by recordable medium volumes of the multiple plates, and can be protected by top and/or bottom protecting regions made in the top and/or bottom of the multiple plates. Preferably, the protection regions along the sides of multiple plates' data volumes extend across all the recording monolithic plates, taking into account potential leakage of light through the interface regions between the plates.

In yet other embodiments of the invention, the data carrier (including one or multiple plates) may be further formed with additional mechanical protection. This can be implemented either by providing separate mechanically strengthened cover(s) or coatings at the outer surface(s) of the carrier, or by incorporating appropriate material(s), e.g. cross linkers such as ethylene glycol dimethacrylate, into an outer layer of the carrier.

Thus, an optical data carrier of the present invention comprises photochemically-active medium which has an inner recordable volume intended for containing recorded data, and has an outer (peripheral) non-recording region of a certain predetermined thickness surrounding outer borders of said internal recorded volume. The outer non-recording region of the recordable medium serves as protecting layer, and its thickness is dictated by the nature of incident light. The protecting layer according to the present invention does not require any addition of either a physical or photochemical foreign barrier which may alter the properties of the photochemically-active medium.

The use of the technique of the present invention, i.e. implementation of the protective layer within the photochemically-active medium having similar or the same optical properties as the data volume medium provides for the protecting layer that removes potentially damaging light: Any incident light that could potentially reach the data containing volume of the recordable medium and alter it in a non desired fashion is first absorbed by the protective region. The protective region could thus be considered to be acting as a “sacrificial absorber” of a volume region that may be used for data storage layers and turning them into a protective layer. It should be understood that the photochemically-active medium is not damaged by this absorbance.

One of the advantages of the invented approach is that the absorbance of the protecting region is exactly matched to the requirements of the data volume, i.e. absorbing more at the wavelengths that have better chances of acting in a harmful way. Because of this exact match, spectral bandwidth is not wasted (i.e. no wavelengths are unnecessarily blocked), and therefore other functions of the disk (e.g. a fluorescent signal) are not impeded.

Thus, according to the invention, the protecting region is not necessarily a physically distinct component of the data carrier, as is required with a cover layer according to the conventional techniques. Since the data volume and the protecting region utilize the similar or same photochemical moiety, they may be composed of the similar or same material composition. Therefore, a monolithic structure may be produced, of which the portion close to the surface or “outer region” is designated as the “protecting region” and the internal portion is designated the “data storage region or volume”. This design means that manufacturing costs and complexity are reduced, and optical quality is increased.

As indicated above, a specifically designed cover plate with enhanced mechanical properties (e.g. scratch resistance or higher mechanical strength) may additionally be used (as a mechanically protective carcass) comprising a substantially similar photo-responsive composition to smoothly integrate the cover plate in terms of spectral response and/or refractive index.

It should be understood that the data volume and the protecting region interfacing it may be of the same or similar photo-responsive compositions. The similar photo-responsive compositions may for example be compositions comprising different derivatives of the same photo-active material provided they have similar optical properties (spectral and/or dispersion properties); and/or different concentrations of said photo-active material, practically providing the same optical protection at different thickness of the protecting region (e.g. including a thickness of a separate cover plate as the case may be).

The cover plate may be placed above/below the recordable medium (single- or multi-plate). Such a cover plate if used is preferably configured for providing additional mechanical protection for the data carrier being for example a scratch resistance layer or a carcass made of conventional spectrally clear material with no required optical protection properties (as described above), e.g. made of polycarbonate (transparent material). The protecting region is located within the recordable medium, below the cover plate.

The optical protecting region described not only gives excellent protection of the internal region for ambient light, but also provides a buffer zone for other potentially damaging processes. The effects of optical irregularities on the surface of the data carrier and of mechanical trauma to the data carrier are also largely isolated in this region protecting the internal data region. The potential difficulty of adding an additional mechanical protection layer with strict optical requirements is thus significantly reduced.

The format of the data carrier is determined in part by the thickness of the protecting layer (or the depth of the data volume). Therefore, the format defines the required thickness of the protecting region and/or desired protection level, thereby affecting the composition and structure of the optical storage carrier.

Thus, according to one broad aspect of invention, there is provided an optical data carrier comprising recordable media having an outer surface and an inner data volume in which data is to be recorded, said data volume being spaced from said outer surface a certain minimal distance D, a region of the recordable media surrounding the data volume providing at least optical protection for said data volume.

The protecting region may have the same optical properties as the data volume (e.g. being an integral part of the recordable medium containing the data volume), or may have similar optical properties as the data volume medium (e.g. being a cover made of the data volume medium, of a material comprising the same or similar photo-absorbing ingredients and compositions, and/or a region of the data volume medium doped or coated by additional material(s) providing additional mechanical protection for the data volume.

The data volume contains a three-dimensional pattern of spaced-apart recorded regions. The recordable medium is preferably a non-linear medium, comprising one or more chemical groups that can interact with light, and the interaction with light of a recording beam yields said recoded pattern, while reading may be performed by interaction with light of a reading beam causing read signal (fluorescence pattern) from the recorded data pattern. The medium is such that at least one of recording and reading processes is based on multi-photon interaction. The distance D is selected to attenuate ambient light passing through the protective region to a level in which it will not cause said harmful interactions.

It should be understood that the data volume is preferably spaced predetermined distance(s), equal or not, from all outer surfaces of the data carrier, e.g. from the top and bottom surfaces, and possibly also from the side surface(s).

The chemical groups interacting with light may be materials that can switch from one isomeric form to another upon interaction with light. Preferably, the medium is comprised of 4′-ethoxy-stilbenedicyano-4-propyl-methyl(meth)acrylate. Various examples of such type of recordable media are described in the following publications WO 07007319, WO 06075327, WO 06075329, WO 0173779, WO 06075328, WO 03070689, all assigned to the assignee of the present application.

According to a specific but not limiting example, the distance between the outer surface of the data carrier and the data volume (i.e. the thickness of the protecting region) is at least 5 microns. The recording light beam and the reading light beam are of the same or different wavelengths in a range from about 630 to about 830 nm, and the attenuation factor of light of other potentially harmful wavelength ranges within the protective region is 10⁵-10¹⁰.

According to another broad aspect of the invention, there is provided an optical data carrier comprising recordable media having an outer surface and an internal data volume, said data volume being spaced from said outer surface a certain minimal distance D, thereby defining a region of the recordable medium surrounding the data volume and providing at least optical protection for said data volume.

According to yet another aspect of the invention, there is provided an optical data carrier comprising recordable media for optically recording data therein and reading the recorded data, at least a region of a predetermined thickness of said recordable medium along an outer surface of the medium being configured for absorbing light of wavelength ranges that are to be prevented from reaching a volume of the medium intended for recording data therein.

According to yet further broad aspect of the invention, there is provided an optical data carrier configured for recording data in and reading data from a recordable volume surrounded by a protecting region, the data carrier comprising information about the type of the data carrier indicative of a minimal distance from an outer surface of a recordable medium for location of the data.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a UV-VIS absorbance spectrum of eMMA (4′-ethoxy-stilbenedicyano-4-propyl-methyl (meth)acrylate) suitable for use as a recordable medium in an optical data carrier of the present invention.

FIG. 2 is a schematic cross section of an exemplary embodiment of the optical data carrier of the present invention.

FIG. 3 is an enlarged section of the exemplary embodiment of the photochemically activated storage media/disc.

### DETAILED DESCRIPTION OF THE PREFERRED EMBODIMENTS

The present invention provides a novel technique for protection of data recorded in an optical data carrier from various environmental effects. The invention is particularly useful for optical data carriers of a type utilizing a non-linear recordable medium or photochemically-active recordable medium and is therefore described below with respect to this specific application. The use of such non-linear medium allows for recording data in the form of a three-dimensional pattern of spaced-apart recorded regions or marks arranged within a recording volume in multiple virtual planes or layers. The optical data carrier can include one or more plates each comprising such recordable medium. The optical data carrier (e.g. the plate) can include one or more reference layers, where such reference layer presents a reflective interface with a recording layer. The principles of using reference layers and its configurations are described for example in WO 07/069243 and WO 07/083308 both assigned to the assignee of the present application.

According to the invention, the optical data carrier comprises recordable media having an inner data volume (formed by one or multiple plates as described above) and a protecting region between an outer surface of the data carrier and said inner data volume. This protecting region is a portion of the recordable media (namely having similar or same optical properties, i.e. spectral and/or dispersion properties, as the data volume medium) of a predetermined thickness located above and/or below and/or aside said inner data volume. Thus, the inner data volume is located at a certain depth from the outer surface of the recordable medium. The data volume within photochemically-active recordable media is thus at least optically protected by the protecting layer of the recordable media (i.e. having the same or similar spectral and/or dispersion properties as the data volume), rather than by an optically and physically separate cover layer. Since the protecting layer used in the data carrier structure of the present invention is not explicitly a physical layer, the commonly used term “cover layer” is not used and the term “protecting region” is more appropriate. The protecting region is a portion of the data carrier recordable medium near to the outer surface thereof that is used in order to maintain the integrity of the internal regions.

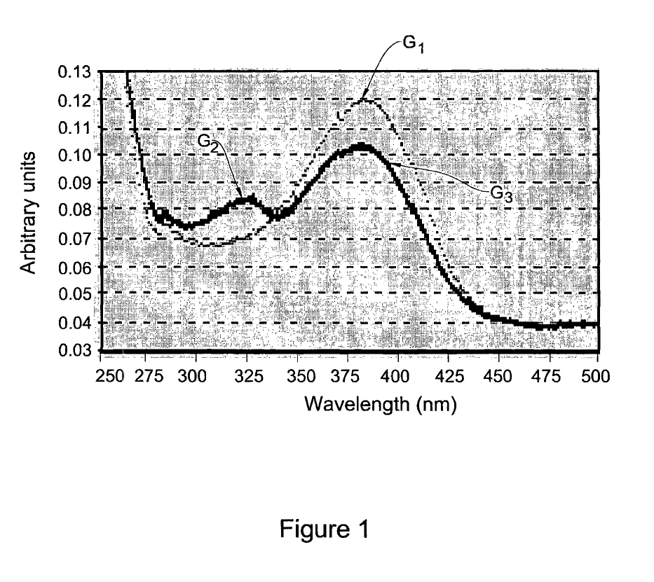

Reference is made to FIG. 1 illustrating the optical characteristics of a photo-active material comprising recordable media suitable to be used in a data carrier of the present invention. In this example, a low concentration solution of a dicyanostilbene derivative bound to methyl(meth)acrylate) (termed eMMA) is used. A 1×1 mm cuvette was filled with a weak solution (1 microgram/mL in chloroform) of eMMA (95:5 trans:cis as determined by HPLC). FIG. 1 shows the ultra violet-visible (UV-VIS) absorption spectrum of such solution under different conditions of exposure to (ambient) potentially harmful irradiation. Curve G₁, (represented by cross marks) corresponds to a portion of the eMMA-solution in a cuvette without a protecting layer before exposure to potentially harmful irradiation. When the eMMA solution was kept in the dark, it was found to be stable over a period of days. However, a pronounced change in the UV-VIS absorption spectrum of the eMMA solution was observed following a 5 minutes of exposure in low ambient light (inside a room with small windows during the daytime, without direct sunlight or additional artificial lighting)—curve G₂ represented by triangular marks. This resulting state is a ˜40:60 mixture of the trans and cis isomers, which was found to correspond to the photostationary state. This is indicated by curve G₃ represented by a solid curve substantially overlapping curve G₂, that was measured after additional 20 minutes exposure that did not result in any further changes. A near-identical result was obtained using hexane as the solvent. The photostationary state portrayed by curves G₂ and G₃ corresponds to recordable medium which was exposed to harmful irradiation and converted by this radiation into a medium that is in a non-switchable state, i.e. a medium in which marks cannot be recorded and/or differentiated from the surrounding space.

The thickness of the protecting region, and its ability to remove the need for a “cover layer” was demonstrated by attempting to read and write data to and from monolithic recordable media at various distances from the outer surface thereof. Data has been recorded within a data volume in the recordable medium comprising 10% eMMA, using a high NA lens (NA=1.3), with a data volume being located at a distance D of about 100-150 micron from the outer surface of the recordable medium. This was measured by moving an actuator on which the data carrier was positioned relative to an objective lens of the optical system. Subsequently, the recorded data was retrieved in the dark without ambient light, and marks of 10% modulation depth were provided.

The sample was then exposed to ambient light and to indirect sunlight, and the data was retrieved again with no detectable decrease in mark modulation depth. Marks were recorded with an immersion oil lens with Numerical Aperture of 1.3 at a distance of 150-200 microns from the outer surface of the recordable medium comprising 10% eMMA, and data was read without any significant loss of contrast after exposure to in house ambient illumination.

It should be understood that the optical protection property of a relatively thin region of a recordable medium is attributed to the use in the recordable medium compositions comprising high concentrations of photo-absorbing materials. This provides for using a recordable medium with significant absorption at the wavelength ranges in which the linear absorbance energy provides enough energy to harmfully activate the photo-active medium.

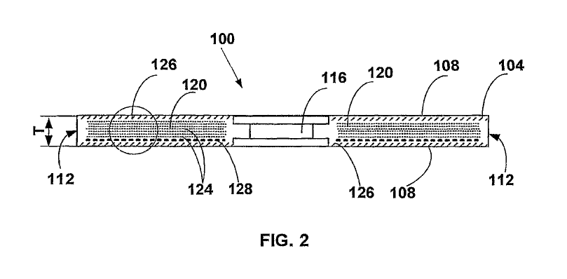

Reference is made to FIG. 2 presenting a cross section of an exemplary embodiment of a data carrier 100 of the present invention. Data carrier 100 comprises a non-linear recordable medium 104, comprising photochemically-active moieties, e.g. such as those of FIG. 1, bound to a polymeric backbone or being part of the polymer's backbone. The photochemically-active moieties are capable of changing their state from one isomeric form to another upon interaction with electromagnetic energy, such as laser radiation. As further shown in the figure, the data carrier 100 is associated with a mounting bore 116 for mounting and clamping the carrier 100 on a spindle of an optical recording/reading apparatus.

Data is optically recordable in the recordable medium 104 within an inner volume portion 120 in the form of a pattern of spaced-apart marks or recorded regions, which may be in practically any location, although it is convenient to record it on a plurality of “virtual” layers 124. A distance between the layers 124 may be about 5-15 microns. The recordable medium 104 has outer surfaces 108 (top and bottom surfaces) and 112 (cylindrical side surface) defining an outer region or layer 126 surrounding the data volume 120.

In the present example, the outer region 126 surrounds the data volume 120 above, below and aside thereof, but it should be understood that generally such a protecting region may be at either one of external surfaces of the data carrier. The outer region 126 of the recordable media 104 has a predetermined minimal thickness T₁ (which may vary for example from 5 to 150 microns) and represents a protecting region for protecting the data volume 120 from various environmental effects. In the present example, the protecting region 126 is an integral layer of the recordable medium and has the same optical properties as the data volume 120. It should however be understood that generally the protecting region 126 may be constituted by or implemented in a cover plate (e.g. carcass) having substantially similar optical properties as the data volume, i.e. having substantially similar photo-responsive composition having similar spectral and/or dispersion properties and thus being part of the recordable media of the data carrier, but also having improved mechanical properties (e.g. improved scratch resistance or mechanical strength). Surfaces 108 may additionally be coated by appropriate materials(s) providing optical and/or mechanical protection, for example anti-reflective coatings.

Thus, the protecting region 126 may be an integral part of the recordable medium having the same chemical composition as the inner data volume 120, and although being capable of being used as a data carrying region, is not intended for data recording but serves as the protecting region. For example, in case of a formatted data volume, formatting-recording-indications (e.g. sampled servo and/or headers and headers' identities) may extend only to the recordable volume thus indicating that the protecting region should not be used for recording. In case a reference layer is being used, similar information indicating the type of the data carrier and the allowed regions for data recording and the protecting regions is included in data embedded in the reference layer (pattern in the reference layer). For example, certain format (data pattern) is made in the data carrier (e.g. in a reference layer), which data is read by an optical system before starting actual data recording. The format includes instruction data about a depth of a data volume in the carrier (a distance from an outer surface of the data carrier) and is used for directing and focusing a recording beam during the data recording and a reading beam during the data reading process. In this connection, it should be understood that generally, the data carrier may be pre-formatted and may provide information indicative of the type of the data carrier, the structure of the data carrier, the specific allowed recordable regions (or recordable volume) and the prohibited protecting regions.

The predetermined minimal thickness T₁ of the protecting region 126 defines a minimal required depth of the data volume within the recordable medium, i.e. a distance D from the outer surface 108, 112 to the closest thereto recording plane/layer. Thicker protecting regions/layers may reduce the carrier capacity, since they diminish the number of recordable layers for a given dimension of the data carrier.

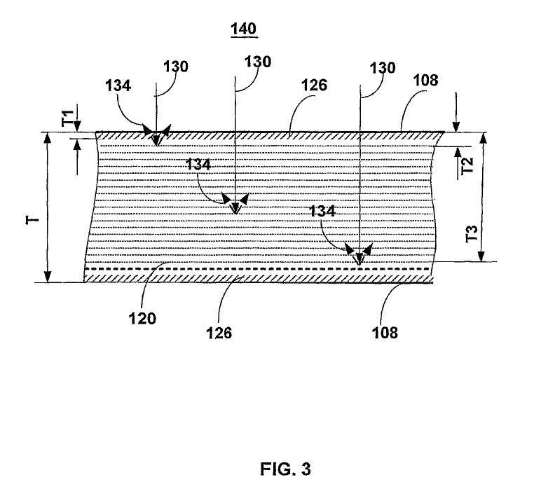

Turning now to FIG. 3, there is exemplified more specifically the arrangement of layers in a recorded data volume 120 with the recordable medium, and the principles of data reading in the data carrier. As shown, a reading laser beam 130 of a predetermined wavelength is applied to the data carrier to scan the inner data volume 120 and thereby cause a fluorescence pattern (read signal) therefrom, indicative of the arrangement of recorded marks and spaces in the data volume. Each interrogated recorded mark emits a luminescent light component 134. A light detection system 140 is appropriately provided to detect this light signal 134 and communicate data indicative thereof to a controller (not shown) which is appropriately preprogrammed to interpret the read-out data. Interrogated positions are located at different depths T₂ through T₃ in the recordable medium. In case the recordable medium respond to a reading light by fluorescence, the luminescent read-out signal 134 is a weak signal and a significant part of it may be absorbed within the recordable medium. Linear absorption is proportional to (i) the concentration of the absorbing material, in this case the photoactive moiety, (ii) the absorption coefficient, and (iii) the length (depth) the radiation travels in it. For example, luminescent signal 134 generated at depth T₃ is absorbed to a greater extension than luminescent signal 134 generated at depth T₂. Thus, it is extremely important to have the recordable medium minimally absorbing the luminescent radiation 134, or in other words the recordable medium substantially transparent to the luminescent radiation 134.

The use of photo-active materials such as eMMA (4′-ethoxy-stilbenedicyano-4-propyl-methyl (meth)acrylate) having a large stokes shift (preferably larger than 70 nm, more preferably higher then 100 nm) enables the efficient use of the light spectrum, allowing for opening a spectral window for the fluorescence signal in which the photon energies are not high enough so as to potentially cause harmful interaction with the recordable medium. Using the protective region in the recordable medium enables keeping this spectral window open.

As further shown in the figure, the recordable medium 120 has a protecting region 126. In the present example, the minimal required thickness for the protecting layer is T₁, while the closest thereto recording layer is located deeper, i.e. at a distance T₂ from the top surface of the recording medium and distance T₃ from the bottom surface, where T₂>T₁ and T₃>T₂.

Thus, the present invention provides a simple and effective solution for data protection in optical information carriers. The present invention in its broadest aspect provides at least optical protection for the data volume by defining a minimal depth for embedding the data volume within the recoding medium.

While this invention has been particularly shown and described with references to preferred embodiments thereof, it will be understood by those skilled in the art that various changes in form and details may be made therein without departing from the scope of the invention encompassed by the appended claims.

1. An optical data carrier comprising recordable media having an outer surface and an inner data volume in which data is to be recorded, said data volume being spaced from said outer surface a certain minimal distance D, a region of the recordable media surrounding the data volume providing at least optical protection for said data volume.

2. The optical data carrier according to claim 1, wherein the recordable media is configured for creation of the data volume comprising data in the form of a three-dimensional pattern of spaced-apart recorded regions arranged in multiple planes.

3. The optical data carrier according to claim 2, wherein the recordable media is non-linear media, in which at least one of data recording and data reading processes is based on multi-photon interaction.

4. The optical data carrier according to claim 1, wherein said minimal distance D is selected to provide attenuation of ambient light passing through the protecting region to a level which prevents ambient light from causing the recording and reading interactions within the data volume

5. The optical data carrier according to claim 1, wherein the data volume is spaced at least said predetermined second distance from at least one other outer surface of the recordable media.

6. The optical data carrier according to claim 3, wherein said recordable media comprises photochemically active media comprising chemical groups that can switch from one isomeric form to another upon the interaction with light.

7. The optical data carrier according to claim 6, wherein the recordable media comprises 4′-ethoxy-stilbenedicyano-4-propyl-methyl (meth)acrylate, said minimal distance D being of at least 5 μm.

8. The optical data carrier according to claim 7, wherein the data in recordable in said media as a result of interaction with a recording light beam having a wavelength in a range from about 630 to about 830 nm, the attenuation of light of wavelengths of potentially harmful effects in the protecting region being 10⁵-10¹⁰.

9. The optical data carrier according to claim 7, wherein the recorded data is readable as a result of interaction with a reading light beam having a wavelength in a range from about 630 to about 830 nm, the attenuation of light of wavelengths of potentially harmful effects in the protecting region being 10⁵ to 10¹⁰.

10. The optical data carrier according to claim 4, wherein said protecting region has similar or same optical properties as said data volume.

11. The optical data carrier according to claim 10, wherein said protecting region is an integral region of the data volume media.

12. The optical data carrier according to claim 10, wherein said protecting region contains a different material composition as compared to that of the data volume.

13. The optical data carrier according to claim 12, wherein the protecting region has the material composition making it of higher mechanical strength than the data volume.

14. The optical data carrier according to claim 10, comprising a cover layer on top of said outer surface, said cover layer being transparent for wavelength ranges used in data recording and reading processes and being configured to provide mechanical protection for the data volume in the recordable media, which contains the data volume and the surrounding protecting region.

15. The optical data carrier according to claim 1, wherein said minimal distance D is selected in accordance with desired capacity of the data volume.

16. The optical data carrier according to claim 1, wherein the data volume is embedded in the recordable media at a distance from the outer surface of the recordable media not less than said minimal distance D.

17. The optical data carrier according to claim 1, comprising information about the type of the data carrier indicative of said minimal distance from the outer surface for recording/reading the data volume.

18. The optical data carrier according to claim 1, wherein said recordable media comprises a plurality of recordable media regions located in a plurality of monolithic plates, respectively, located one on top of the other.

19. The optical data carrier according to claim 18, wherein each of top and bottom recordable media regions comprising the protecting region between the outer surface of the respective recordable media region and data volume.

20. The optical data carrier according to claim 19, wherein each of the recordable media regions comprises the protecting region between the respective outer side surfaces and the data volume.

21. The optical data carrier according to claim 4, wherein at least the protecting region of the recordable media is configured to be absorbable with respect to light of wavelength ranges which should be prevented from reaching the data volume.

22. An optical data carrier comprising a body comprising recordable media defining top and bottom surfaces and a cylindrical side surface, the recordable media comprising at least one protecting region in between an inner data volume and at least one of said surfaces, respectively, said at least one protecting region preventing deleterious radiation from penetrating said recordable media to reach the data volume.

23. An optical data carrier comprising a data volume embedded within a recordable media at a distance from an outer surface of the recordable media, where said distance is not less than a certain minimal value selected to provide a protecting region of the recordable media ensuring at least optical protection for the data volume.

24. An optical data carrier configured for recording data in and reading data from a recordable volume surrounded by a protecting region, the data carrier comprising information about the type of the data carrier indicative of a minimal distance where the recordable volume is to be located to enable recording/reading data in/from said volume.

25. An optical data carrier comprising one or more monolithic plates, each comprising recordable media for recording/reading a data volume therein, said optical data carrier comprising protective regions extending along side surfaces of the carrier, said protecting region having similar or same optical properties as the data volume.
